(19) United States
(12) Patent Application Publication
(10) Pub. No.: US 2016/0230955 A1
(43) Pub. Date: Aug. 11, 2016

(54) OPTICAL MODULE

(71) Applicant: EI LIGHTING CO., LTD., Incheon (KR)

(72) Inventors: Myong Gi JANG, Incheon (KR); Jong Hyun CHOI, Incheon (KR)

(73) Assignee: El Lighting Co., LTD., Incheon (KR)

(21) Appl. No.: 14/894,658

(22) PCT Filed: May 27, 2014
(86) PCT No.: PCT/KR2014/004704

§ 371 Date: Nov. 30, 2015

(51) Int. Cl. F21V 7/00; F21V 17/10

(52) U.S. Cl. CPC F21V 7/0033; F21V 7/0066; F21V 17/101; F21Y 2101/02

(57) ABSTRACT

Provided is an optical module. The optical module includes a substrate; a light emitting diode provided on the substrate; a first member that is provided in front of the substrate, transmits some of the light emitted from the light emitting diode and reflects some other light; and a second member that is provided between the substrate and the first member so as to be spaced apart from the first member at a predetermined interval, is formed with an exposed region by which the light emitting diode is exposed at a position corresponding to the light emitting diode, and re-reflects the light reflected by the first member forward again.

### CROSS-REFERENCES TO RELATED APPLICATION

This application is a Section 371 of International Application No. PCT/KR2014/004704, filed on May 27, 2014, and the disclosure of which is incorporated herein by reference.

### BACKGROUND OF THE INVENTION

1. Field of the Invention

The present invention relates to an optical module that uses a light emitting diode as a light source, and more particularly, to an optical module in which a multiple reflection structure is provided between light emitting diodes to allow a slim design, even while reducing the number of light emitting diodes.

2. Description of the Related Art

A light emitting diode (LED) has emerged as a light source for a back light applied to a non-light emitting display, such as a next-generation lighting source and a liquid crystal display (LCD), and it application field has expanded.

However, the light emitting diode has a problem of a high cost as compared to a conventional light source, the price competitiveness of the final product has fallen due to a fetal problem of a point light source, and an aspect of difficulty in achieving a free product design has been pointed out as a disadvantage.

Thus, in an optical device, such as an LED surface lighting and an LCD backlight using a light emitting diode as a light source, cost saving and an improvement in design are the most important development requirements.

For the cost savings and improvement in design, the conventional optical module using a light emitting diode as a light source will be described first with reference to FIGS. 1 and 2, and problems thereof will be confirmed.

Here, FIG. 1 is a cross-sectional view illustrating an example of an internal structure of a conventional optical module, and FIG. 2 is a cross-sectional view illustrating another example of the internal structure of the conventional optical module.

First, referring to FIG. 1, in the conventional optical module, a substrate 30 is provided between a display panel 20 and a frame 10, and a plurality of light emitting diodes 40 is mounted on a substrate 30. Each light emitting diode 40 is located behind the display panel 20 to emit light to a predetermined area of the display panel 20.

Next, referring to FIG. 2, another optical module with the smaller number of light emitting diodes 40 than the optical module illustrated in FIG. 1 is illustrated, and in this case, since it is possible to reduce the number the light emitting diodes 40, it is possible to reduce the unit cost of the product.

However, in this case, since a single light emitting diode 40 needs to cover a larger area of the display panel 20, a spaced distance between the display panel 20 and the substrate 30 naturally increases. Therefore, a spaced distance between the frame 10 and the display panel 20 also increases, and there is a problem of an increase in total thickness of the optical module.

Consequently, fundamental problem is caused in which, in the case of an optical device that uses a light emitting diode having a characteristic of a point light source, when making much account of a design, the number of the light emitting diodes increases, and in contrast, to reduce the number of the light emitting diodes, it is required to abandon a slim design.

In order to solve these problems, an effort of trying to reduce the number of the light emitting diodes by utilizing a light guide plate and simultaneously secure the design is in progress. However, there are problems in that, with addition of the light guide plate, luminous efficiency decreases, the weight of the optical device increases, and, when applied to a large-sized optical device, it is difficult to manufacture a light guide plate of a corresponding size.

Therefore, there are needs for methods for solving the above-described problems, and the present invention described in detail below has been made as a part of such methods.

### SUMMARY OF THE INVENTION

An aspect of the present invention is directed to solve the aforementioned problems of the conventional optical module and to provide an optical module capable of providing a slim design, while reducing the number of light emitting diodes.

Further, the aspects of the present invention are not limited to those mentioned above, and other aspects that have not been mentioned will be clearly understood by those skilled in the art from the following description.

According to an embodiment of the present invention, there is provided an optical module that is configured to include a substrate; a light emitting diode provided on the substrate; a first member that is provided in front of the substrate, transmits some of the light emitted from the light emitting diode and reflects some other light; and a second member that is provided between the substrate and the first member so as to be spaced apart from the first member at a predetermined interval, is formed with an exposed region by which the light emitting diode is exposed at a position corresponding to the light emitting diode, and re-reflects the light reflected by the first member forward again.

Further, the optical module according to the present invention may be configured to further include a support member that is provided between the first member and the substrate or between the first member and the second member and supports the first member to maintain a distance between the first member and the light emitting diode.

Here, when the support member is provided between the first member and the substrate, the second member is formed with a passage hole through which the support member passes, and a solder is formed on a surface being in contact with the substrate, and the support member may be fixed to the substrate.

Meanwhile, when the support member is provided between the first member and the second member, the support member may be fixed to the first member and the second member by an adhesive resin.

Meanwhile, the support member may be formed of a material having transmittivity to transmit the light emitted from the light emitting diode.

Further, the support member may be configured to include a vertical section provided around the light emitting diode; and a horizontal section that is connected to the vertical section and is provided in front of the light emitting diode to come into contact with the first member.

Here, in at least one or more of the vertical section and the horizontal section, a transmission region that transmits some of the light emitted from the light emitting diode, and a reflection region that reflects some of the light emitted from the light emitting diode may be formed.

At this time, the vertical section and the horizontal section may be formed of a material having transmittivity such that these sections can transmit the light emitted from the light emitting diode, a reflective material may be coated on a part of the horizontal section so that the reflective region can be formed in a part of the horizontal section, and the reflective material coated on a part of the horizontal section may be coated to a wider area as it goes to the position corresponding to the light emitting diode.

Meanwhile, the vertical section and the horizontal section are formed of a material having non-transmittivity to be able to block or reflect the light emitted from the light emitting diode, and a part of the horizontal section may be opened so that the transmission region can be formed in a part of the horizontal section, and the part of the opened horizontal section may be opened to a smaller area as it goes to a position corresponding to the light emitting diode.

In addition, when the transmission region is formed in a part of the horizontal section, the transmission regions formed in a part of the horizontal section may be formed so as to intersect with a transmission region provided in the first member to be able to transmit some of the light emitted from the light emitting diode.

Meanwhile, in the optical module according to the present invention, the first member may be formed with a transmission region that transmits some of the light emitted from the light emitting diode or a reflection region that reflects some of the light emitted from the light emitting diode.

Here, the first member is formed of a material having transmittivity such that it can transmit light emitted from the light emitting diode, and a reflective material may be coated so that the reflection region is formed in a part of the first member.

At this time, the reflective material coated on the first member may be coated to a wider area, as it goes to the position corresponding to the light emitting diode.

Further, the first member is formed of a material having non-transmittivity so that it can reflect or block the light emitted from the light emitting diode, and a part of the first member may be opened so that the transmission region can be formed in a part of the first member.

At this time, the part of the opened first member may be made up of one or more passage holes through which the light emitted from the light emitting diode can pass. In this way, when the part is made up of one or more passage holes, the passage holes may be formed with different densities or individual areas depending on the position corresponding to the light emitting diode and the intensity of light emitted from the light emitting diode.

At this time, the densities of the passage holes may increase or the individual areas of the passage holes may increase, as the passage holes are spaced apart from the position corresponding to the light emitting diodes.

Further, the densities of the passage holes may decrease or the individual areas of the passage holes decrease as the passage holes are spaced apart from a position perpendicular to the light emitting diode to a predetermined position, and then, as the passage holes are further spaced beyond the predetermined position, the densities may increase or the individual areas of the passage holes may increase.

Meanwhile, in the optical module according to the present invention, the exposed region of the second member may be formed in the form of an insertion hole to which the light emitting diode is inserted.

According to the optical module according to the present invention suggested through the above-described technical solutions, since the multiple reflection structures are provided between the light emitting diodes, is possible to provide a slim design, while reducing the number of light emitting diodes.

The effects of the present invention are not limited to the above-mentioned effect, and other effects that have not been mentioned will be clearly understood from the scope of the claims to those skilled in the art.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a cross-sectional view illustrating an example of an internal structure of a conventional optical module;

FIG. 2 is a cross-sectional view illustrating another example of the internal structure of a conventional optical module;

FIG. 3 is a cross-sectional view illustrating a first embodiment of an optical module according to the present invention;

FIG. 4 is a cross-sectional view illustrating a path of light in the first embodiment illustrated in FIG. 3;

FIG. 5 is a cross-sectional view illustrating a modified example of the first embodiment illustrated in FIG. 3;

FIG. 6 is a cross-sectional view illustrating another modified example of the first embodiment illustrated in FIG. 3;

FIG. 7 is a plan view illustrating an example of an arrangement of a light emitting diode and a support member in the first embodiment of the optical module according to the present invention;

FIG. 8 is a plan view illustrating another example of the arrangement of the light emitting diode and the support member in the first embodiment of the optical module according to the present invention;

FIG. 9 is a plan view illustrating a first form of a first member in the first embodiment of the optical module according to the present invention;

FIG. 10 is a plan view illustrating a second form of the first member in the first embodiment of the optical module according to the present invention;

FIG. 11 is a plan view illustrating a third form of the first member in the first embodiment of the optical module according to the present invention;

FIG. 12 is a schematic diagram for explaining the third form of the first member illustrated in FIG. 11.

FIG. 13 is a plan view illustrating a fourth form of the first member in the first embodiment of the optical module according to the present invention;

FIG. 14 is a schematic diagram for explaining the fourth form of the first member illustrated in FIG. 13;

FIG. 15 is a plan view illustrating a fifth aspect of the first member in the first embodiment of the optical module according to the present invention;

FIG. 16 is a cross-sectional view illustrating the second embodiment of the optical module according to the present invention;

FIG. 17 is a cross-sectional view illustrating a path of light in the second embodiment illustrated in FIG. 16;

FIG. 18 is a plan view illustrating an example of the arrangement of the light emitting diode and the support member in the second embodiment of the optical module according to the present invention;

FIG. 19 is a plan view illustrating another example of the arrangement of the light emitting diode and the support member in the second embodiment of the optical module according to the present invention;

FIG. 20 is a perspective view illustrating a first form of the support member which is deformed in the second embodiment of the optical module according to the present invention;

FIG. 21 is a perspective view illustrating a second form of the support member which is deformed in the second embodiment of the optical module according to the present invention;

FIG. 22 is a perspective view illustrating a third form of the support member which is deformed in the second embodiment of the optical module according to the present invention;

FIG. 23 is a perspective view illustrating a fourth form of the support member which is deformed in the second embodiment of the optical module according to the present invention;

FIG. 24 is a partially cut perspective view illustrating an example of a lighting device in which the optical module according to the present invention is applied; and

FIG. 25 is a partially cut perspective view illustrating another example of a lighting device in which the optical module according to the present invention is applied.

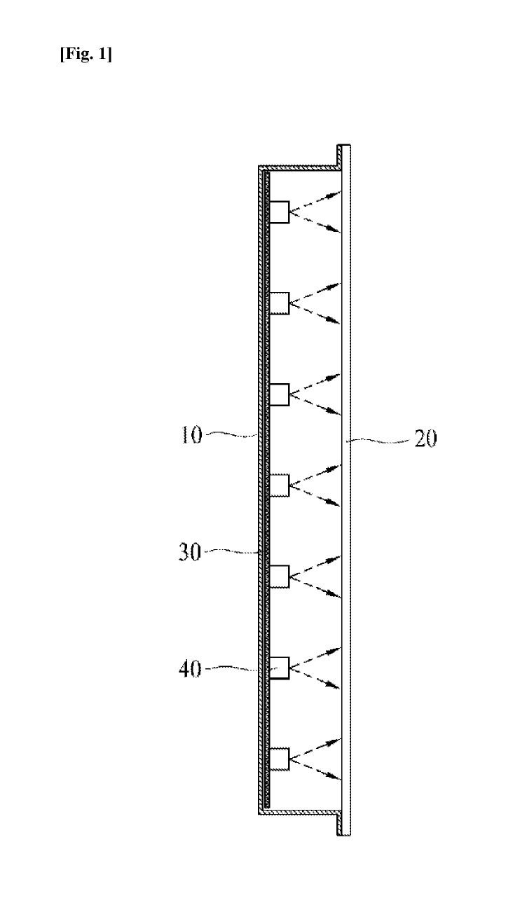

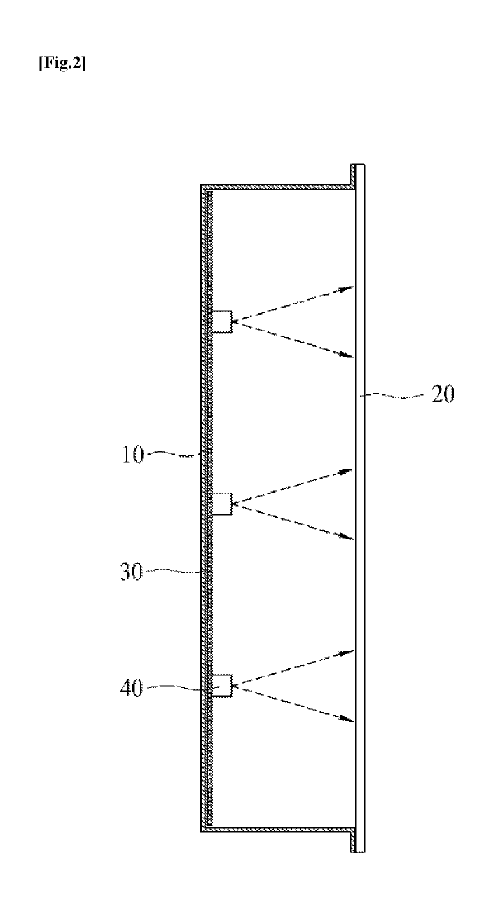

### DETAILED DESCRIPTION OF EXEMPLARY EMBODIMENTS

Exemplary embodiments of the present invention will be described below in detail with reference to the accompanying drawings. Wherever possible, the same reference numerals will be used to refer to the same elements throughout the specification, and a duplicated description thereof will be omitted. It will be understood that although the terms “first”, “second”, etc. are used herein to describe various elements, these elements should not be limited by these terms. These terms are only used to distinguish one element from another element.

Hereinafter, a preferred embodiment of the present invention in which an object of the present invention can be concretely achieved will be described with reference to the accompanying drawings. In describing the present embodiment, the same configurations are denoted by the same names and the same reference numerals, and an additional description thereof will be omitted.

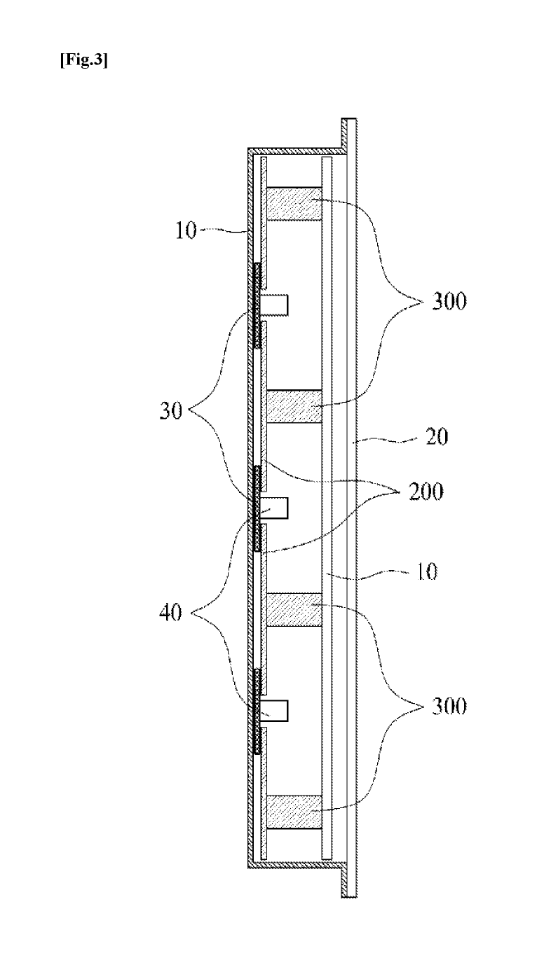

First, a first embodiment of an optical module according to the present invention will be described in detail referring to FIGS. 3 to 15.

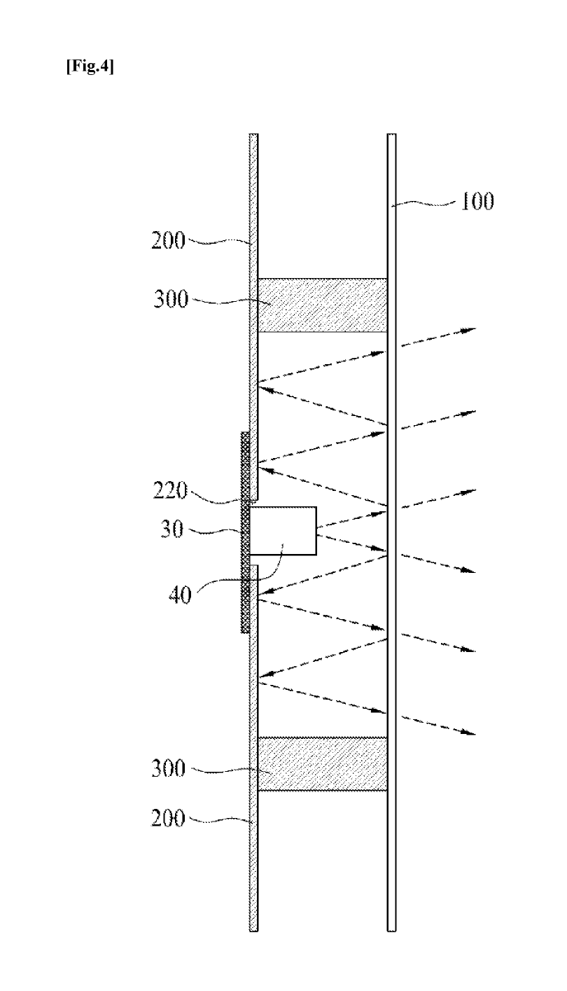

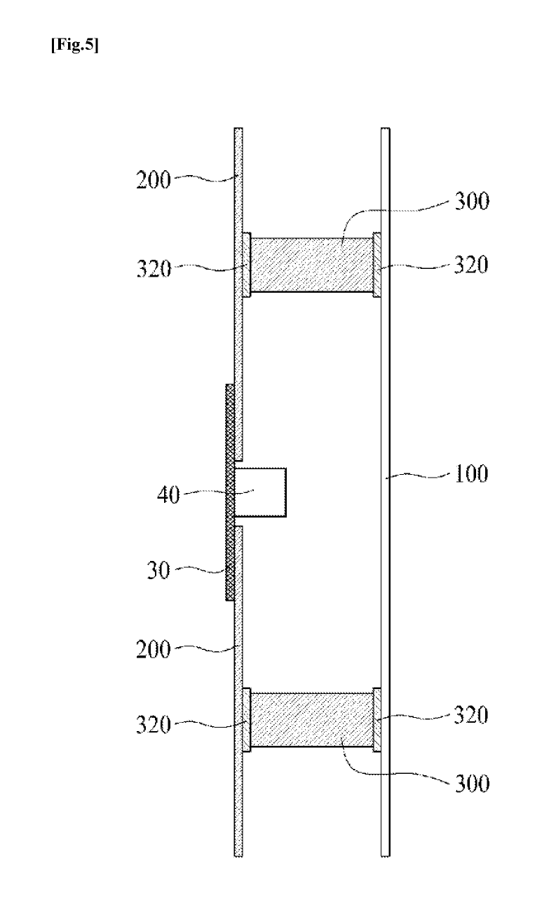

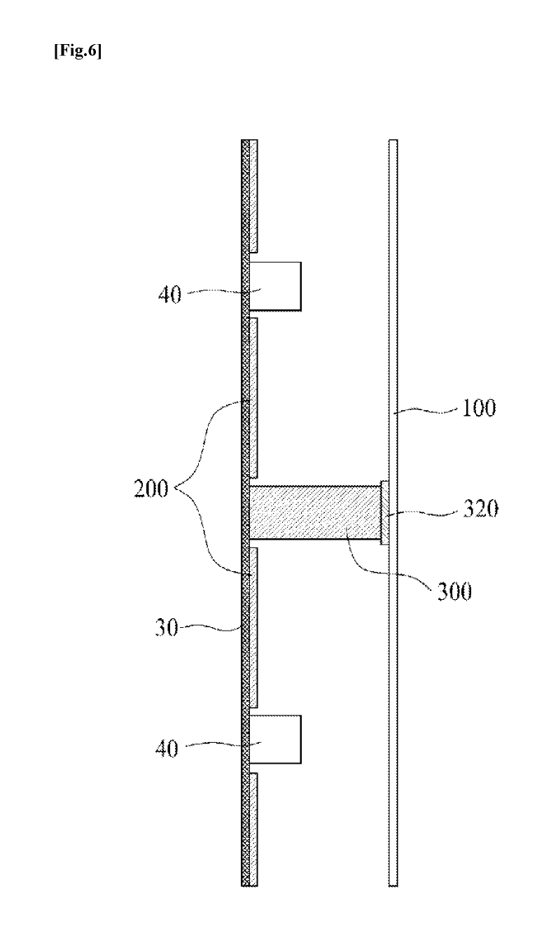

Here, FIG. 3 is a cross-sectional view illustrating a first embodiment of an optical module according to the present invention, FIG. 4 is a cross-sectional view illustrating a path of light in the first embodiment illustrated in FIG. 3, FIG. 5 is a cross-sectional view illustrating a modified example of the first embodiment illustrated in FIG. 3, and FIG. 6 is a cross-sectional view illustrating another modified example of the first embodiment illustrated in FIG. 3.

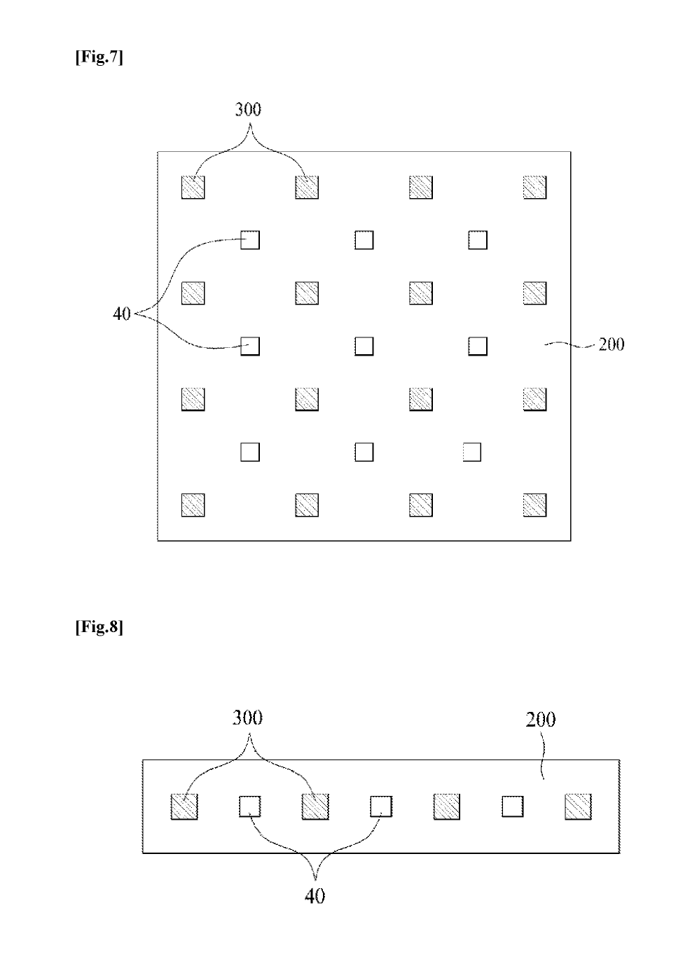

Further, FIG. 7 is a plan view illustrating an example of an arrangement of a light emitting diode and a support member in the first embodiment of the optical module according to the present invention, and FIG. 8 is a plan view illustrating another example of the arrangement of the light emitting diode and the support member in the first embodiment of the optical module according to the present invention.

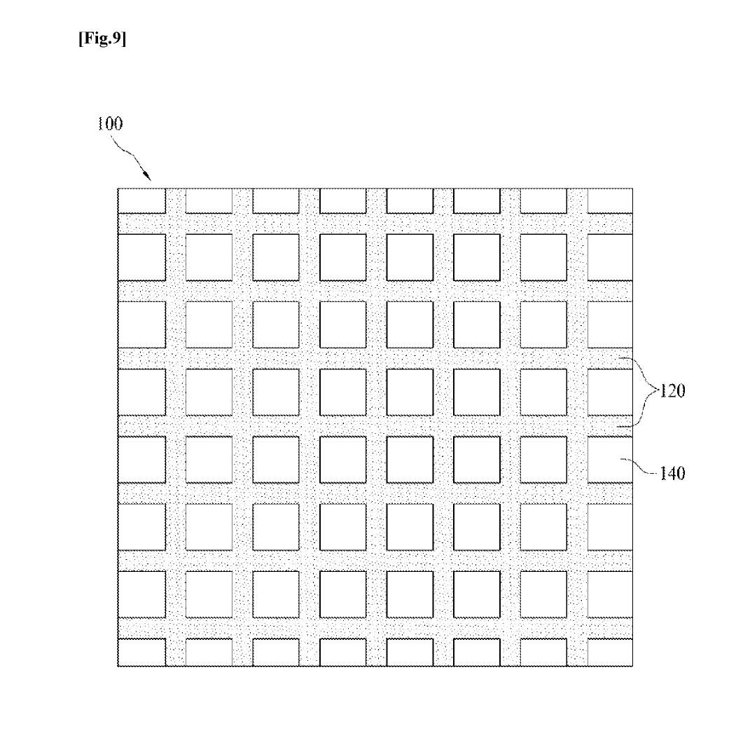

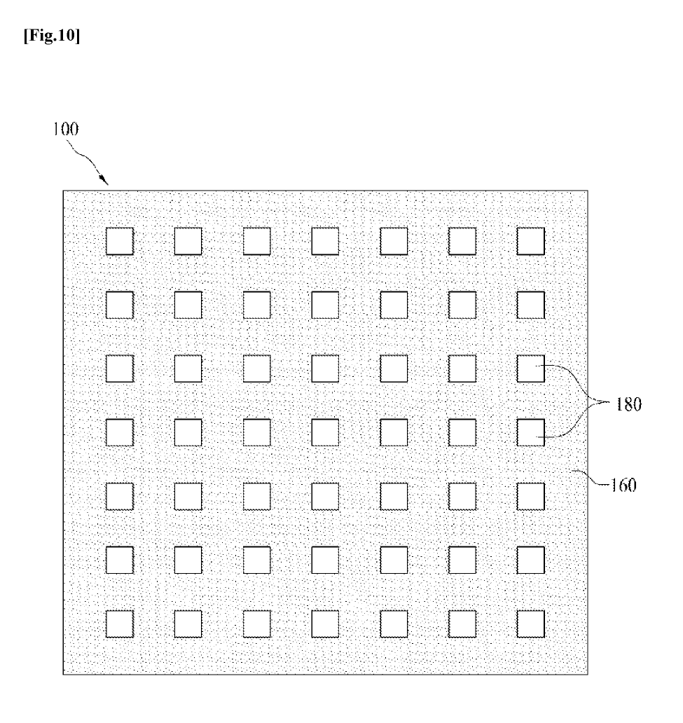

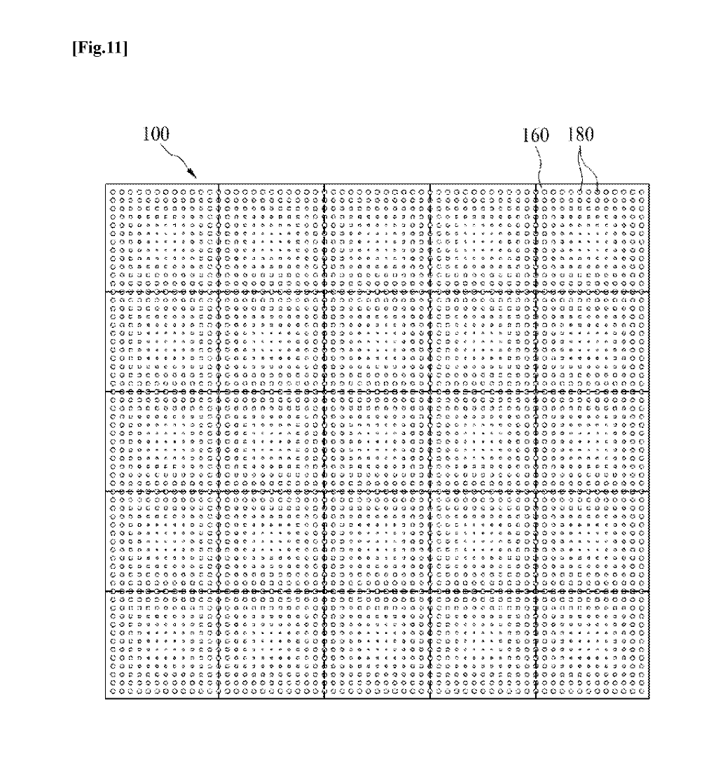

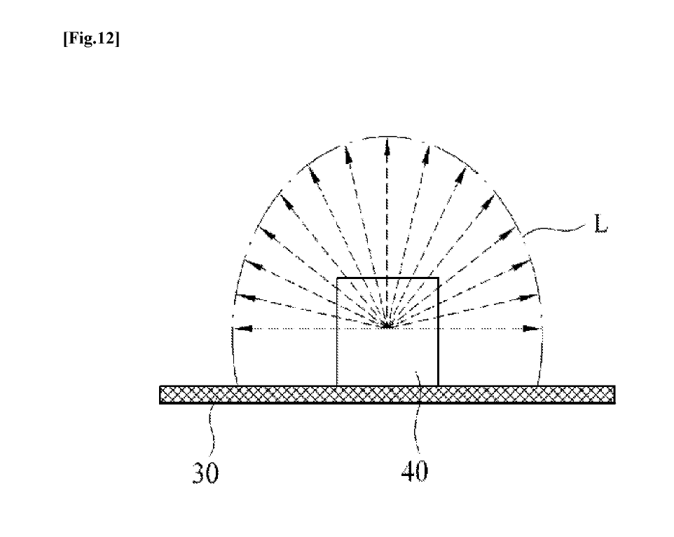

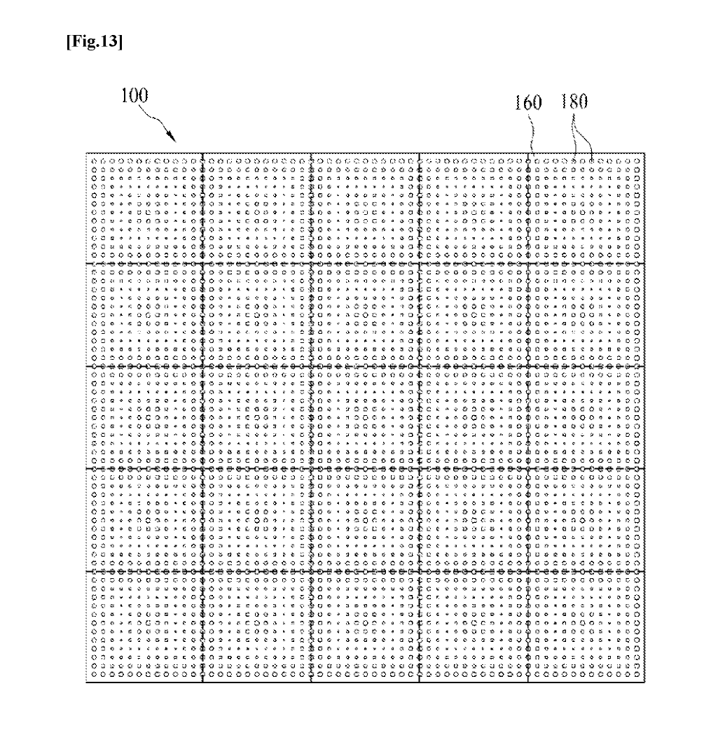

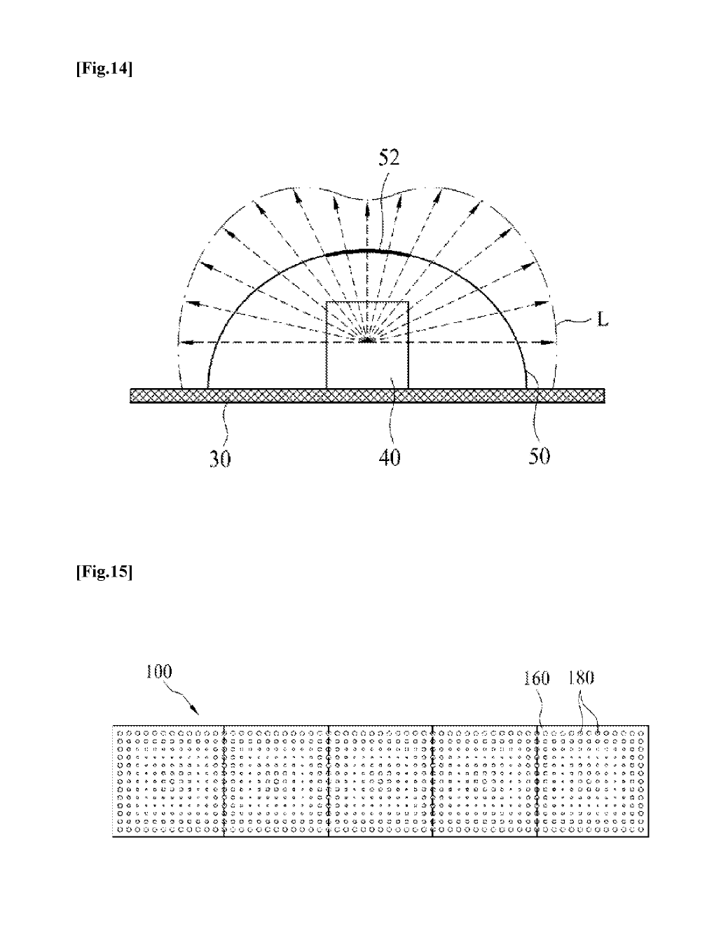

Also, FIG. 9 is a plan view illustrating a first form of a first member in the first embodiment of the optical module according to the present invention, FIG. 10 is a plan view illustrating a second form of the first member in the first embodiment of the optical module according to the present invention, FIG. 11 is a plan view illustrating a third form of the first member in the first embodiment of the optical module according to the present invention, FIG. 12 is a schematic diagram for explaining the third form of the first member illustrated in FIG. 11, FIG. 13 is a plan view illustrating a fourth form of the first member in the first embodiment of the optical module according to the present invention, FIG. 14 is a schematic diagram for explaining the fourth form of the first member illustrated in FIG. 13, and FIG. 15 is a plan view illustrating a fifth aspect of the first member in the first embodiment of the optical module according to the present invention.

As illustrated in FIGS. 3 to 15, the first embodiment of the optical module according to the present invention includes a first member 100, a second member 200 and a support member 300, in addition to a frame 10, a display panel 20, a substrate 30 and a light emitting diode 40.

Here, since the frame 10 and the display panel 20 may be achieved in various forms, depending on the type of products to which the first embodiment of the optical module according to the present invention is applied, for example, LCD displays, and this is obvious to those skilled in the art, the detailed description thereof will be omitted.

In the following description, a direction in which the display panel 20 is located in the LCD display is defined as a front, and a direction in which the frame 10 is disposed is defined as a rear.

A substrate 30 is a circuit configured to apply power to the light emitting diode 40, and a light emitting diode 40 is mounted on the substrate 30. At this time, a method of mounting the light emitting diode 40 on the substrate 30 may be various.

That is, a plurality of substrates 30 is provided, and the light emitting diodes 40 can be provided one by one for each substrate 30. Moreover, without being limited thereto, a plurality of light emitting diodes 40 may be mounted on a single substrate 30, or a single substrate 30 may also be provided to cover the whole area rather than being provided in multiple numbers.

Meanwhile, as described above, since the light emitting diode 40 itself emerges as a next generation light source for illumination and a light source for a back light applied to the non-light emitting display as described in the background art above, it is obvious to those skilled in the art, and its detailed description will also be omitted.

Meanwhile, the first member 100 is a component that is provided in front of the substrate 30 to be able to transmit some of the light emitted from the light emitting diode 40 forward, and to reflect another part rearward.

That is, by the first member 100, some of the light emitted from the light emitting diode 40 is transmitted to the display panel 20, and another part is reflected toward the second member 200 side.

The first member 100 may be formed of various materials having characteristics of transmitting and simultaneously reflecting the light as described above. For example, there is no limit as the first member 100, even such as glass, sheet, plastic or metal.

Furthermore, various methods can be used to have both reflection and transmission characteristics of light. That is, it is also possible to have the above-described characteristics as the material itself, such as forming the first member 100 in a semi-transparent manner, but other methods may also be used. This will be described later.

Meanwhile, the second member 200 is provided between the substrate 30 and the first member 100, and is especially provided so as to be spaced apart from the first member 100 at a predetermined interval. Thus, a space is formed between the first member 100 the second member 200. Further, in the case of this embodiment, a support member 300 is provided to support the first member 100 and the second member 200 each other, and this will be described below.

Further, the second member 200 is formed to have reflectivity, and can re-reflect light emitted from the light emitting diode 40 and reflected by the first member 100 forward. That is, light emitted from the light emitting diode 40 may be directly transmitted to the front of the first member 100 or may be reflected forward again via each of the first member 100 and the second member 40.

That is to say, some of the light emitted from the light emitting diode 40 is directly transmitted to the front of the first member 100, and another part is discharged to the front by being re-reflected by the second member 200 after reflected toward the second member 200 side, which can be understood from the attached drawing.

In this way, in the case of the first embodiment of the optical module according to the present invention, since this procedure is repeated several times, there is an advantage in that a single light emitting diode 40 can cover a wider range. Thus, in the first embodiment of the optical module according to the present invention, since it is possible to reduce the density of light emitting diodes 40, the product cost can be reduced.

In addition, at a position corresponding to the light emitting diode 40 of the whole area of the second member 200, an exposed region in which the light emitting diode 40 is exposed can be formed. This is in order to prevent light emitted from the light emitting diode 40 from being blocked by the second member 200.

That is, the exposed region of the second member 200 is formed in the form of an insertion hole 220 to which the light emitting diode 40 is inserted. That is, in a portion of the second member 200 corresponding to the light emitting diode 40, the insertion hole 220 is formed, and the light emitting diode 40 protrudes through the second member 200.

Therefore, the light emitted from the light emitting diode 40 can be smoothly transmitted to the first member 100 and can form a multiple-reflection structure by the first member 100 the second member 200.

In this way, in this embodiment, although the exposed region of the second member 200 is formed in the form of the insertion hole 220, the exposed region may also be formed in other forms. For example, even when the exposed region is formed of a transmissive material, light of the light emitting diode 40 may be transmitted to the first member 100.

In addition, as in this embodiment, although the insertion hole 220 is formed in the exposed region, it is a matter of course that the light emitting diode 40 is located behind the second member 200 rather than being inserted into the insertion hole 220.

As described above, in the first embodiment of the optical module according to the present invention, a single light emitting diode 40 can cover a wider area of the display panel 20. Therefore, since it is possible to use a smaller number of light emitting diodes 40 as compared to the related art, it is possible to reduce the unit cost when manufacturing the LCD display of the same thickness.

Meanwhile, although the first member 100 described above may be formed of various materials having characteristics of reflecting and transmitting the light as described above, it can be used in various forms as follows to have the reflection and transmission characteristics of light at the same time.

First, the first member 100 according to the first embodiment illustrated in FIG. 9 is formed of a material having transmittivity, and some of the first member 100 is formed to be coated with a reflective material 120.

That is, although the first member 100 itself is formed of the transmissive material 140 that can transmit light, some area may be coated with a reflective material 120 to reflect light.

In particular, in the case of the first member 100 according to the first embodiment illustrated in FIG. 9, it is possible to confirm that the reflective material 120 is coated in the form of a grid.

Also, a reflective material 120 formed on the first member 100 may also be such that its area increase as it goes to a position corresponding to the light emitting diode. Thus, since the possibility of light emitted from the light emitting diode being initially reflected by the reflective material 120 of the first member 100 increases, the probability of the multiple reflection also increases.

The reflective material 120 as described above also naturally has various arrangements due to selection.

Next, the first member 100 according to the second embodiment as illustrated in FIG. 10 is formed of a material 160 having reflectivity unlike the first embodiment illustrated in FIG. 9, and one or more passage holes 180 are formed through which the light emitted from the light emitting diode passes.

That is, the first member 100 itself of the second embodiment blocks or reflects the light and can allow the light to pass by forming one or more passage holes 180.

In particular, in the case of the first member 100 according to the second embodiment illustrated in FIG. 10, it is possible to confirm that the passage holes 180 are arranged along a plurality of rows and columns.

Moreover, a plurality of passage holes 180 is formed in the first member 100, and its density may decrease as it goes to the position corresponding to the light emitting diode 40. Thus, since the probability of light emitted from the light emitting diode 40 being initially reflected by the surface of the first member 100 increases, the probability of multiple reflection also increases.

As another method, the individual areas of the passage holes 180 may decrease as the first member 100 goes to a position corresponding to the light emitting diode 40. That is, it is possible to obtain the same effect as described above, by the configuration in which the area of the passage hole 180 gradually decreases as it gets close to the light emitting diode 40.

These methods are confirmed from the first member 100 of the third embodiment illustrated in FIG. 11, and the first member 100 of the fourth embodiment illustrated in FIG. 13, and this will be described in more detail through FIGS. 12 and 14.

When there is no other component that adjusts the intensity of light in front of the light emitting diode 40 as illustrated in FIG. 12, since a region L in which light of the strongest intensity is emitted in the direction perpendicular to the substrate 30 is formed in the first member 100 of the third form illustrated in FIG. 11, it is possible to configure the passage hole 180 so that the density increases as it is spaced apart from a position corresponding to the light emitting diode 40 or the individual areas of the passage holes 180 increases.

Meanwhile, in the first member 100 of the fourth form illustrated in FIG. 13, as illustrated in FIG. 14, when there is another component that adjusts the intensity of light in front of the light emitting diode 40, that is, an adjustment lens 50, the region L in which the light of the strongest intensity is emitted will not be formed in the direction perpendicular to the substrate 30. Therefore, in this case, the passage hole 180 needs to be configured in a different way in consideration of the intensity of the light emitted from the light emitting diode 40 depending on the structure of the adjustment lens 50.

As an example, when a blocking film 52 is formed in front of the adjustment lens 50, an area L in which the light of the most high-intensity is emitted in a direction spaced apart from the perpendicular direction of the light emitting diode 40 at a predetermined distance is formed. Accordingly, the passage hole 180 can be configured so that the density decreases or the individual areas of the passage hole 180 decrease as the passage hole 180 is spaced apart from the position perpendicular to the light emitting diode 40 to a predetermined position, and then, the density increases or the individual area of the passage hole 180 increases as the passage hole 180 is further spaced apart from a predetermined position.

In summary, the density or the individual areas of the passage hole 180 formed in the first member 100 can be differently formed, depending on the position corresponding to the light emitting diode 40 and the intensity of light emitted from the light emitting diode 40.

Meanwhile, since the first member 100 of the fifth form illustrated in FIG. 15 is substantially the same as the first member 100 of the above-described fourth form except for a ratio of height and weight, those skilled in the art will be able to sufficiently predict this from the first member 100 of the fourth form, and thus, the description thereof will be omitted.

Meanwhile, as described above, in the case of the first embodiment of the optical module according to the present invention, a support member 300 is provided between the first member 100 and the second member 200, and the support member can be arranged in various ways in order to sufficiently secure a space for reflecting the light of the light emitting diode 40.

As an example, the support members 300 are arranged so as to be spaced apart from each other at predetermined intervals to have a plurality of rows and columns, and the light emitting diodes 40 are arranged so as to be located at the center of the four support members 300. Thus, since each of the light emitting diodes 40 may be maximally spaced apart from each of the support members 300, it is possible to sufficiently secure a space for reflecting the light.

At this time, although a cross-sectional shape of the support member 300 is formed in a square form in this embodiment, the cross-section of the support member 300 may have various shapes such as a circular shape.

Further, the support member 300 can be fixed by forming an adhesive layer 320 between the first member 100 and the second member 200.

At this time, as a method of forming the adhesive layer 320, a method of printing the adhesive material by a screen printing method may be used or a method of using a dispenser or the like may be used.

Further, it is a matter of course that, as the adhesive material used for adhesive layer 320, a Pressure Sensitive Adhesive (PSA) or a UV adhesive can be used, and various other adhesive materials may also be used.

In addition, the first embodiment of the optical module according to the present invention may be deformed in various forms. At this time, although the forms of light emitting diode 40 and the first member 100 are substantially the same, the forms of the substrate 30 and the second member 200 are different, and a fixing type of the support member 300 is also different.

Specifically, a plurality of substrates 30 is not provided, and a single substrate is provided to cover the whole area. Thus, the plurality of light emitting diode 40 is provided on a single substrate 30 by being spaced apart from each other.

Further, in the case of the second member 200, as in the above-described first embodiment before the deformation, although the insertion hole 220 to which the light emitting diode 40 is inserted is formed, in a modified example, a through-hole to which the support member 300 passes is further formed. That is, the support member 300 is provided between the first member 100 and the substrate 30 to pass through the second member 200.

At this time, a surface of the support member 300 coming into contact with the first member 100 is fixed by the adhesive layer 320 in an adhesive manner. Also, a solder is formed on the surface of the support member 300 coming into contact with the substrate 30, and the support member 300 may be bonded to the substrate 30 by a Surface Mount Technology (SMT) manner.

Therefore, since a separate process for forming the adhesive layer is not required when bonding the support member 300 and the substrate 30, it is possible to expect the advantage of the process.

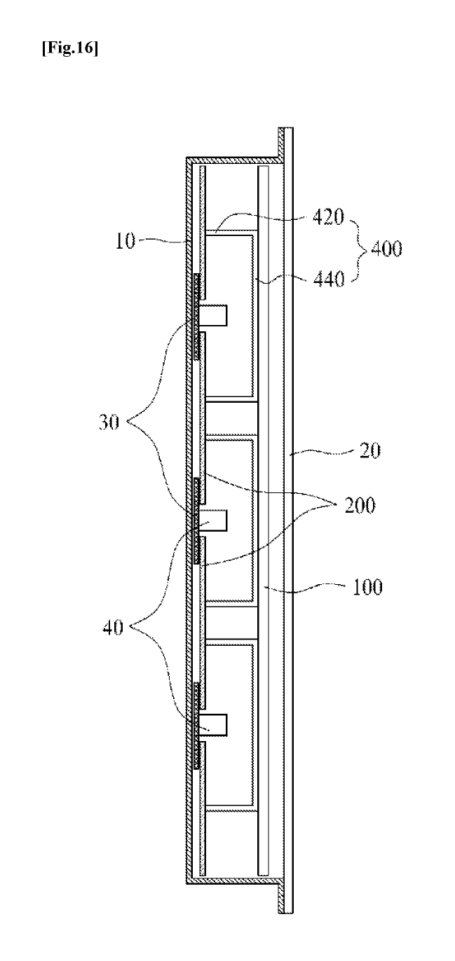

Subsequently, a second embodiment of the optical module according to the present invention will be described in detail referring to FIGS. 16 to 23.

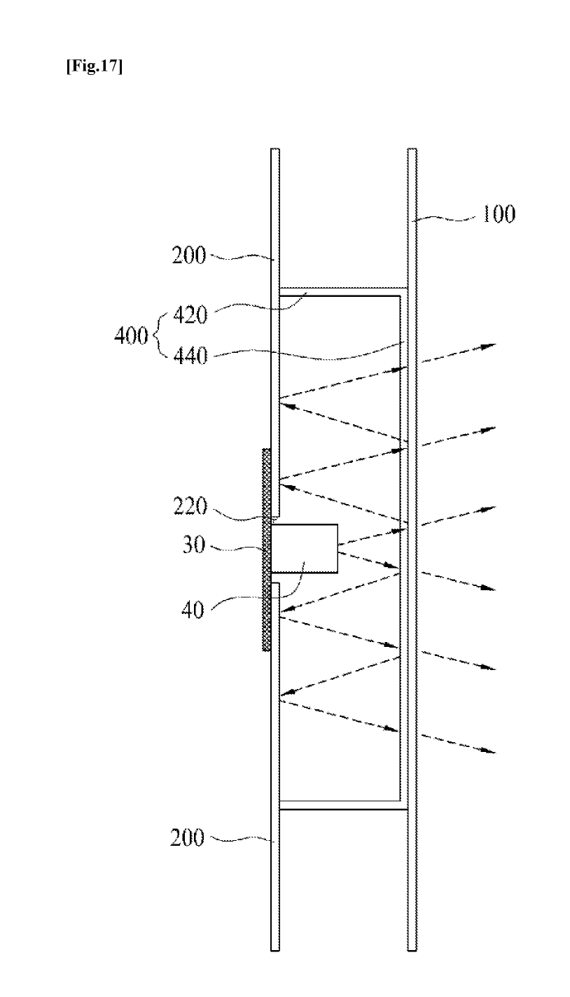

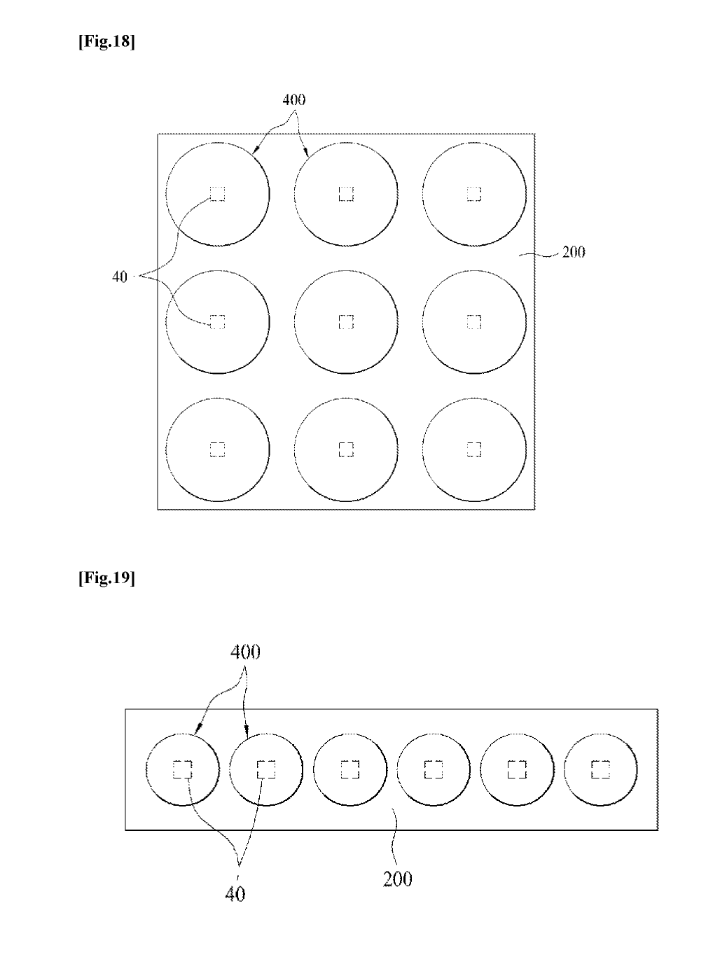

Here, FIG. 16 is a cross-sectional view illustrating a second embodiment of an optical module according to the present invention, FIG. 17 is a cross-sectional view illustrating a path of light in the second embodiment illustrated in FIG. 16, FIG. 18 is a plan view illustrating an example of an arrangement of the light emitting diode and the support member in the second embodiment of the optical module according to the present invention, and FIG. 19 is a plan view illustrating another example of arrangement of the light emitting diode and the support member in the second embodiment of the optical module according to the present invention.

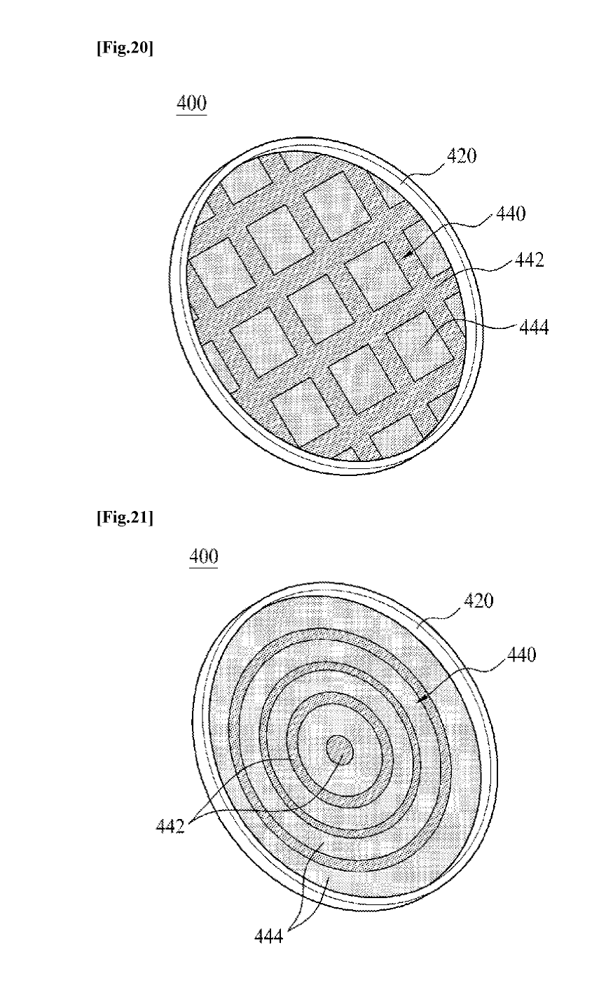

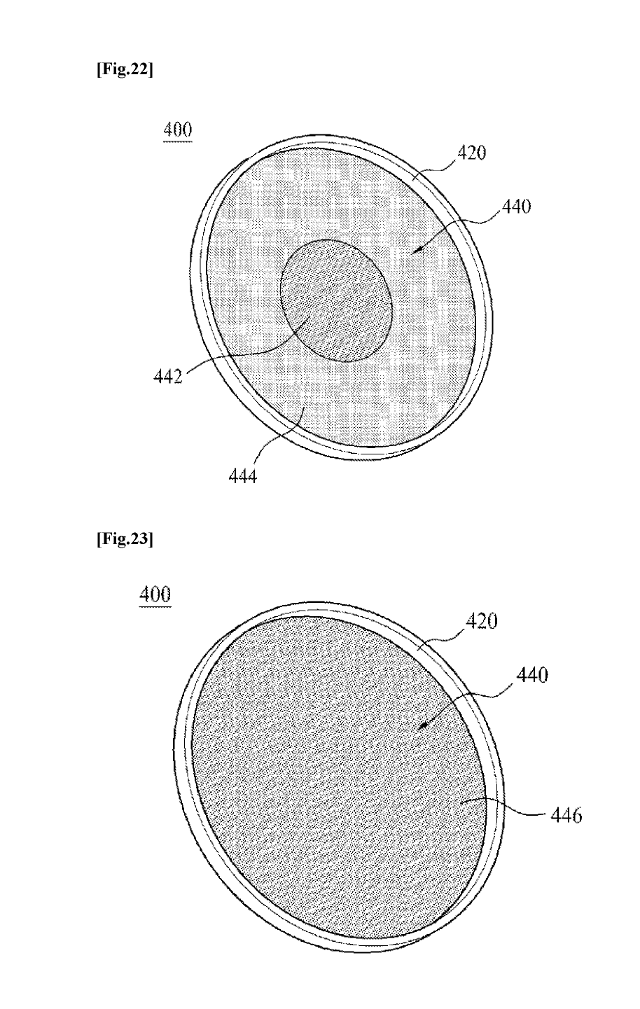

Further, FIG. 20 is a perspective view illustrating a first form of the support member which is deformed in the second embodiment of the optical module according to the present invention. FIG. 21 is a perspective view illustrating a second form of the support member which is deformed in the second embodiment of the optical module according to the present invention, FIG. 22 is a perspective view illustrating a third form of the support member which is deformed in the second embodiment of the optical module according to the present invention, and FIG. 23 is a perspective view illustrating a fourth form of the support member which is deformed in the second embodiment of the optical module according to the present invention.

As illustrated in FIGS. 16 to 23, since the second embodiment of the optical module according to the present invention is the same as the first embodiment except that the support member 300 is modified, hereinafter, the second embodiment will be described in detail on the basis of the deformed support member 400.

Like the above-described support member 300, the deformed support member 400 is disposed between the first member 50 and the second member 60, and comes into contact with each of the first member 50 and the second member 60 to form a support structure.

However, the deformed support member 400 is configured to include a vertical section 420 and a horizontal section 440, unlike the above-described support member 300.

At this time, the vertical section is a component provided around the light emitting diode 40, the horizontal section 440 is a component that is connected to the vertical section 420 and is installed in front of the light emitting diode 40 to come into contact with the first member 100, and the support member is similar to a cup-like shape.

The deformed support member 400 configured to include the vertical section 420 and the horizontal section 440 can also be bonded in various ways, like the above-described support member 300, and there is no limit of the specific shapes of the vertical section 420 and the horizontal section 440.

Further, both of the vertical section 420 and the horizontal section 440 constituting the deformed support member 400 may be formed of a material that transmits the light, and they, in particular, to the horizontal section 440, can also be variously configured as illustrated in FIGS. 20 to 23.

First, when describing the first form of the deformed support member 400 illustrated in FIG. 20, the first form of the deformed support member 400 may be formed of a material 442 that has reflectivity, similarly to or conversely the the-above mentioned first member 100, and one or more passage holes 444 through which the light emitted from the light emitting diodes 40 passes can be formed.

Meanwhile, the second form of the deformed support member 400 illustrated in FIG. 21 is formed in entirely the same shape as the the-above mentioned first member, except for the pattern of the reflective material 442 formed in the horizontal section 440.

Specifically, the reflective material 442 is concentrically formed around the center of the horizontal section 440. Therefore, in this case, since it is possible to form a constant distance between the light emitting diode 40 and the reflective material 442, the uniform and stable reflection can occur, and it is easy to predict the probability.

Meanwhile, although the third form of the deformed support member 400 illustrated in FIG. 22 is formed in entirely the same shape as the above-described first form or the second form, except for the pattern of the reflective material 442 formed in the horizontal section 440.

Specifically, the reflective material 442 is formed to have a circular shape at the central portion of the horizontal section 440. In such a case, it is possible to allow the light emitting diodes 40 to cover a wider range by enhancing the initial reflection probability of light emitted from the light emitting diode 40.

Meanwhile, the fourth form of the deformed support member 400 illustrated in FIG. 23 is also formed in entirely the same shape as the-above mentioned first to third forms, except for the pattern of reflective material 442 formed in the horizontal section 440.

Specifically, the horizontal section 440 may be formed so that the whole area 446 is formed to have reflectivity, unlike the above-described embodiments. That is, in such a case, it is possible to allow the light to be transmitted through the vertical section 420 so that the light is reflected in a wide range as compared to the whole area of the horizontal section 440.

Alternatively, in contrast, the whole area 446 of the horizontal section 440 can be formed to have transmittivity unlike the above-described embodiments. That is, in such a case, the light can be transmitted to the first member 100 as it is, and although the support member serves as a support structure, it is possible to adjust reflection, refraction, or the like of light depending on the transmittivity.

In summary, the horizontal section 440 of the deformed support member 400 may be formed in various forms, which may adjust the intensity of the light emitted from the light emitting diode 40, together with the above-mentioned first member 100.

As an example, in order to further improve the same operating results as the deformed support member 400 illustrated in FIG. 20, a transmission region formed in a part of the horizontal section 440 would be able to be formed to intersect with a transmission region provided in the first member 100.

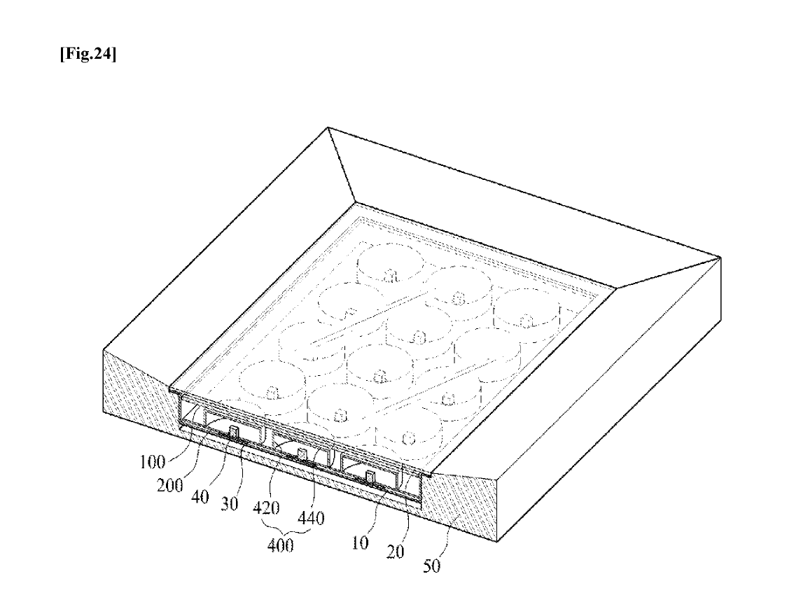

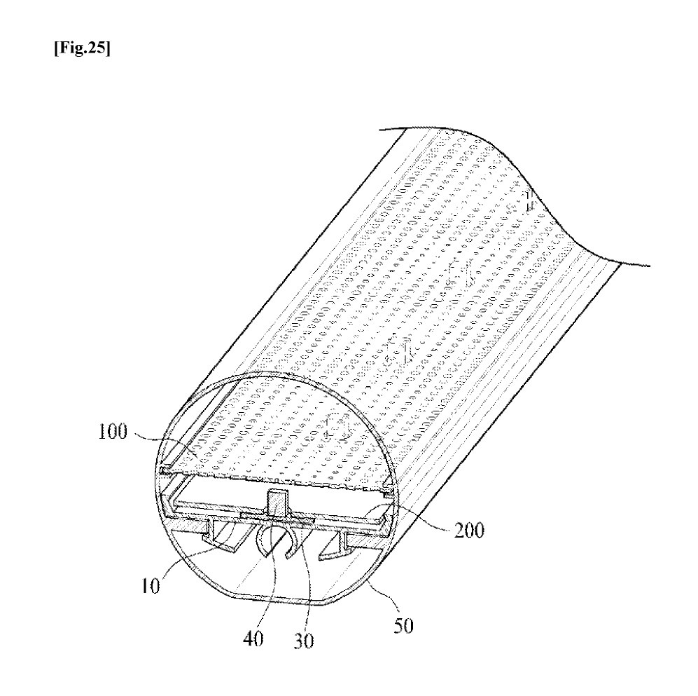

Finally, an application example, effects and the like of the first embodiment or the second embodiment of the optical module according to the present invention will be described in detail with reference to FIGS. 24 and 25.

Here, FIG. 24 is a partially cut perspective view illustrating an example of a lighting device to which the optical module according to the present invention is applied, and FIG. 25 is a partially cut perspective view illustrating another example of a lighting device to which the optical module according to the present invention is applied.

As illustrated in FIGS. 24 and 25, the lighting device to which the optical module according to the present invention is applied may be configured as a lighting device of a surface light emission panel type or may be configured as a lighting device of a line light emission fluorescent lamp type.

It is intended to be applicable to the first embodiment or the second embodiment of the optical module according to the present invention to the lighting device of these various forms, for such application cases, the scope of the invention not limited will take for granted.

Meanwhile, according to the first embodiment or the second embodiment of the optical module according to the present invention, first, there is an advantage capable of thinly forming the overall thickness of the optical module without using a light guide plate, second, there is an advantage capable of significantly reducing the number of light emitting diodes mounted on the optical modules of the same thickness, thereby lowering the production cost, and third, there may be an advantage of excellent versatility since the first member and the second member may be formed of various materials.

It is a matter of course that other advantages may also be derived in addition to the effects of the first embodiment or the second embodiment of the optical module according to the present invention, and the scope of rights of the present invention is not limited due to the effects described above.

While the invention has been illustrated and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

1. An optical module comprising:
a substrate;
a light emitting diode provided on the substrate;
a first member that is provided in front of the substrate, transmits some of the light emitted from the light emitting diode and reflects some other light; and
a second member that is provided between the substrate and the first member so as to be spaced apart from the first member at a predetermined interval, is formed with an exposed region by which the light emitting diode is exposed at a position corresponding to the light emitting diode, and re-reflects the light reflected by the first member forward again.

2. The optical module of claim 1, further comprising:
a support member that is provided between the first member and the substrate or between the first member and the second member and supports the first member to maintain a distance between the first member and the light emitting diode.

3. The optical module of claim 2, wherein, when the support member is provided between the first member and the substrate, the second member is formed with a passage hole through which the support member passes, and a solder is formed on a surface being in contact with the substrate, and the support member is fixed to the substrate.

4. The optical module of claim 2, wherein, when the support member is provided between the first member and the second member, the support member is fixed to the first member and the second member by an adhesive resin.

5. The optical module of claim 2, wherein the support member is formed of a material having transmittivity so as to transmit the light emitted from the light emitting diode.

6. The optical module of claim 2, wherein the support member comprises a vertical section provided around the light emitting diode; and a horizontal section that is connected to the vertical section and is provided in front of the light emitting diode to come into contact with the first member.

7. The optical module of claim 6, wherein in at least one or more of the vertical section and the horizontal section, a transmission region that transmits some of the light emitted from the light emitting diode, or a reflection region that reflects some of the light emitted from the diode may be formed.

8. The optical module of claim 7, wherein the vertical section and the horizontal section are formed of a material having transmittivity such that these sections can transmit the light emitted from the light emitting diode, and a reflective material is coated on a part of the horizontal section so that a reflective region can be formed in a part of the horizontal section.

9. The optical module of claim 8, wherein the reflective material coated on a part of the horizontal section is coated to a wider area as it goes to a position corresponding to the light emitting diode.

10. The optical module of claim 7, wherein the vertical section and the horizontal section are formed of a material having non-transmittivity to be able to block or reflect the light emitted from the light emitting diode, and a part of the horizontal section is opened so that the transmission region can be formed in a part of the horizontal section.

11. The optical module of claim 10, wherein a part of the opened horizontal section is opened to a smaller area as it goes to a position corresponding to the light emitting diode.

12. The optical module of claim 7, wherein, when the transmission region is formed in a part of the horizontal section, the transmission region formed in a part of the horizontal section is formed so as to intersect with a transmission region provided in the first member to be able to transmit some of the light emitted from the light emitting diode.

13. The optical module of claim 1, wherein the first member is formed with a transmission region that transmits some of the light emitted from the light emitting diode or a reflection region that reflects some of the light emitted from the light emitting diode.

14. The optical module of claim 13, wherein the first member is formed of a material having transmittivity such that it can transmit light emitted from the light emitting diode, and the first member is coated with a reflective material so that the reflection region can be formed in a part of the first member.

15. The optical module of claim 14, wherein the reflective material coated on the first member is coated to a wider area, as it goes to the position corresponding to the light emitting diode.

16. The optical module of claim 13, wherein the first member is formed of a material having non-transmittivity so that it can reflect or block the light emitted from the light emitting diode, and a part of the first member is opened so that the transmission region can be formed in a part of the first member.

17. The optical module of claim 16, wherein the part of the opened first member is made up of one or more passage holes through which the light emitted from the light emitting diode can pass.

18. The optical module of claim 17, wherein the passage holes are formed with different densities or individual areas depending on the position corresponding to the light emitting diode and the intensity of light emitted from the light emitting diode.

19. The optical module of claim 18, wherein densities of the passage holes increase or the individual areas of the passage holes increase, as the passage holes are spaced apart from the position corresponding to the light emitting diode.

20. The optical module of claim 18, wherein the densities of the passage holes decrease or the individual areas of the passage holes decrease as the passage holes are spaced apart from a position perpendicular to the light emitting diode to a predetermined position, and then, as the passage holes are further spaced beyond the predetermined position, the densities increase or the individual areas of the passage holes increase.

21. The optical module of claim 1, wherein the exposed region of the second member is formed in the form of an insertion hole to which the light emitting diode is inserted.
